(19) United States
(12) Patent Application Publication
(10) Pub. No.: US 2007/0186673 A1
(43) Pub. Date: Aug. 16, 2007

(54) Food bar fragility tester

(75) Inventor: John Steiger, Glenview, IL (US)

Correspondence Address: PEPSICO, INC.;c/o GOODWIN PROCTER LLP, 599 LEXINGTON AVE, NEW YORK, NY, 10022, US

(73) Assignee: The Quaker Oats Company, Chicago, IL (US)

(21) Appl. No.: 11/341,726

(22) Filed: Jan. 27, 2006

(51) Int. Cl. G01N 3/08

(52) U.S. Cl. 73/818

(57) ABSTRACT

A food bar fragility testing apparatus tests the fragility characteristics of a food bar specimen. The specimen is placed on first and second support rods with one end of the specimen abutting a sidewall of the frame of the tester. The support rods are spaced from the sidewall parallel to each other and the sidewall. A pivotal arm with a force applying surface engages the food bar specimen and bisects distance between the support rods. A press generates a force that is transmitted to the food bar specimen through the arm to determine if the food bar specimen can withstand the force without fracturing. The apparatus can also be used to classify relative fragility among specimens of various compositions. The apparatus is adaptable to allow use of a free weight, to rather than a press, to generate a force to thereby provide a portability feature.

### FIELD OF THE INVENTION

This invention relates to an apparatus for testing food bars. More specifically, the invention relates to a device for classifying and quantifying the fragility of a food bar specimen.

### BACKGROUND OF THE INVENTION

Food bars have grown in popularity as people have become increasingly health conscious in their eating habits. Food bars are available in various food types and may be given specialized classifications, such as protein bars, weight watching bars, low carbohydrate bars, organic bars and the like. One reason for their popularity is that they can provide a healthy alternative to candy bars and other snacks. In addition, many of the food bars now available are so nutritious that they can be substituted for a complete meal.

Food bars may be comprised of a wide variety of formulations. Changes in the formulations, however, can vary the structural integrity of a food bar. Also, various inclusions in a food bar, such as raisins, almonds and chocolate chips, can also affect the strength characteristics of a food bar. Since food bars are typically hand held while being consumed, it is particularly important that they have a satisfactory level of structural stability and do not easily break apart or crumble. Thus, in addition to the usual considerations for food products, such as taste, texture and appearance, it is important that any formulation selected allows production of a structurally acceptable food bar product. Moreover, once a specific formulation for a food bar is selected and commercial mass production of the food bar takes place, it is also important to be able to test and control the quality of food bars to ensure that the food bars produced are not unduly fragile due do inconsistencies in the manufacturing process.

Therefore, a need exists for an apparatus and method that allows fragility classification of food bars of various formulations and inclusions. A need also exists for a food bar fragility test apparatus for providing quality control of the structural integrity of commercially mass produced food bars.

### BRIEF SUMMARY OF THE INVENTION

In accordance with one aspect of the present invention, a food bar fragility test apparatus is provided that can conduct fragility tests for food bars to determine their fragility and to provide quality control in food bar manufacturing.

In accordance with another aspect of the invention, a method is provided for classifying relative fragility among a series of food bar specimens to aid in the development of formulations for commercially sold food bars.

In one aspect of the invention a food bar fragility tester for testing the fragility characteristics of a food bar specimen is provided that has a frame with a base and a sidewall extending generally perpendicularly from the base. The apparatus includes a support structure for positioning and supporting a food bar test specimen that includes a first and second support rod. The support structure for the specimen also includes the sidewall of the frame. The support rods are positioned on the base parallel to each other and parallel to the sidewall of the frame. The first support rod is spaced a first distance from the frame and the second rod is position a second distance from the sidewall of the frame, the second distance being approximately equal to the food bar specimen length less the first distance.

A force transmitting member is pivotable attached to the top end of the sidewall and includes an arm with a flange having an end providing a force applying surface for contacting the specimen and for applying a force to the specimen. The arm is pivotable to a specimen loading position to allow positioning of the specimen in operative relationship with the support structure. Once the food bar is positioned, the arm is pivotable to a specimen engagement position for apply a force to the specimen. The flange end contacts the specimen along a line which bisects the length of the specimen. A force generator, for generating a measurable and reproducible amount of force, provides a force that is applied the force to the arm. The force is transmitted by the flange to the food bar specimen to determine whether the specimen can withstand the force.

In another aspect of the invention a method of classifying a food bar composition's relative fragility is provided and includes, forming a group of food bar specimens. The specimens each having a generally bar like shape with a first side and a second side, a first end and a second end, a top surface and a bottom surface so that the dimensions of each specimen are approximately the same. The food bar specimens are individually tested by placing a specimen on a support and positioning structure having a plurality of surfaces. One of the structure surfaces supports the specimen at its bottom surface along a first line parallel to the first end of the specimen. The first line is spaced a first distance from the first end of the specimen. A second structure surface supports the specimen along a second line at the bottom surface of the specimen with the second line parallel to the second end of the specimen and spaced a second distance from the second edge of the specimen. The second distance is equal to the first distance. The bottom surface of the specimen is unsupported except along the first and second lines. The position of the specimen is indexed by positioning the first end of the specimen against a third surface of the structure by abutting the first end of the specimen against the third surface. The third surface of the structure is parallel to the first and second lines. Axial movement of the specimen is restrained in one direction at the first edge of the specimen by the third surface. A force is applied to the top surface of the specimen along a third line parallel to the first and second support lines. The third line bisects the first and second lines. A minimum standard bench mark force is set for an acceptable fragility level for the food bar specimens based upon a food bar specimen of a desired strength being able to withstand the bench mark force without fracturing. The food bar specimen composition is classified as non-fragile if the food bar specimen does not fracture when the benchmark force, or greater is applied to the food bar specimen, and is classified as fragile if the food bar specimen fractures when less than the bench force is applied to food bar specimen.

### BRIEF DESCRIPTION OF THE DRAWINGS

FIG. 1 is a side view of the food bar fragility testing apparatus of the present invention showing in dotted lines the pivotable movement of the force transmitting member and the reciprocal movement of the ram;

FIG. 2 is a perspective view of the support frame of the fragility testing apparatus; and

FIG. 3 is a side plan view of the support frame with the arm in a specimen loading position and food bar specimen positioned in the frame.

### DETAILED DESCRIPTION OF THE INVENTION

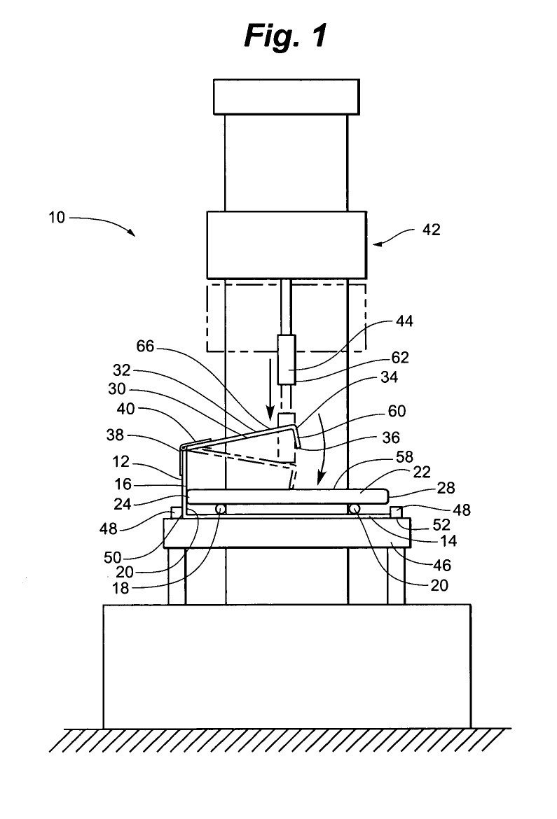

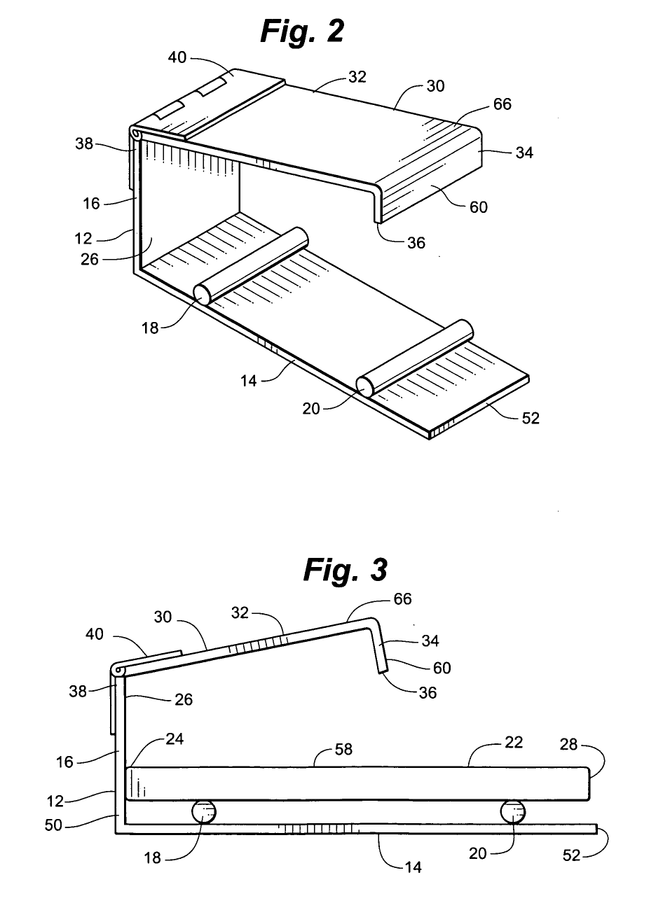

Referring to FIG. 1, a food bar fragility testing apparatus 10 includes a frame 12 having a horizontal base plate 14 and an integrally formed generally vertical sidewall 16. Positioned and secured on base plate 14 are a first support rod 18 and a second identical support rod 20. Support rods 18, 20 are positioned parallel to each other, as well as to frame sidewall 16. For the purpose of conducting a fragility test, a food bar test specimen 22 is placed on rod 18 and rod 20. One end 24 of food bar 22 is abutted against the inner surface 26 on sidewall 16 to provide a standardized positioning relative to rods 18, 20 for the food bars that are tested within food bar testing apparatus 10.

Rods 18, 20 are positioned in a spaced relationship from sidewall 16 and the distance from sidewall 16 is based upon the length of the food bar specimen to be tested. Where the length of food bar 22 is represented by L, and D₁ is the distance between the axial center line of rod 18 and sidewall 16, then the axial center line of rod 20 is positioned a distance D₂ from sidewall 16 where, D₂=L−D₁. In order to conduct a standardized test, and a test that may adequately represent the forces that a food bar is required withstand during its expected customary handling and usage, distance D₁ is selected to be in the range of approximately ⅛ to ⅕ of the length L of the food bar. As a reference, a typical commercially sold food bar has length in the range of 3 to 3.5 inches measured between end 24 and end 28, a width in the range of about 1 to about 1.5 inches and a thickness in the range of about 0.375-0.5 inch. For such length bars, a D₁ of approximately 0.5 inch is preferred.

Food bar frame 12 may be adapted for repositioning rods 18, 20 along various locations on frame base plate 14, as is especially advantageous for testing food bars of various lengths. To allow a repositioning of rods 18, 20 along top surface 21, base plate 14 may, for example, be provided with a series of “V”shaped recesses therein (not shown) parallel to sidewall 16 at various distances from sidewall 16. Rods 18, 20 may then be moved to the locations from sidewall desired by positioning rods 18, 20 into the “V”shaped recesses selected. The selected locations may be based on the length of the food bar specimen 22, or based on the desired type of field conditions being simulated in the testing of the food bar specimen. As another example for allowing adjustable positioning of rods 18, 20, is to provide rods 18, 20 with a flat bottom surface (not shown) to prevent rolling. Base plate 14 may then have a scale (not shown) appearing thereon indicating the distance from sidewall 16 that rods 18, 20 are placed. In these ways, and others readily apparent to those skilled in the art, supports 18, 20 and plate 14 may have various shapes and configurations to allow adjustable positioning of supports 18, 20 to adapt to various food bar specimen shapes, lengths and types of test conditions desired to be simulated. Of course it is also possible to secure rods 18, 20 to base plate 14, such as my welding, if so desired.

Apparatus 10 also has a force transmitting member 30 for transmitting a force to food bar test specimen 22. Member 30 includes an arm 32 with a downwardly depending flange 34. The bottom of flange 34 terminates at an end 36 that provides a force applying surface for contact with the food bar test specimen 22. Arm 32 is pivotally attached in to the top 38 of support frame sidewall 16 by any suitable means, such as a piano hinge 40. The length of arm 32 (L₍ₐ₎) is set at L/2 where L is the length of food bar specimen 22 to be tested. Such a length for arm 32 results in flange end 36 contacting food bar specimen 22 along a line bisecting the distance between rod 18 and rod 20, as well as bisecting the length of the food bar. By causing flange end 36 to contact the food bars at a set location, standardization of the tests may be accomplished.

Testing apparatus 10 also has a force generating means, or press 42, including a ram 44 that reciprocally moves along an axis perpendicular to base 14 of support 12. Press 42 also includes a base table 46 upon which base plate 14 may be positioned and supported. Table 46 may have one or more stops 48, projecting upward from table 46, so that by placing the outer surface 50 of sidewall 16 against stop 48, a desired and standardized alignment between ram 44 and frame 12, and hence flange 34, is accomplished. A second stop 48 may be placed along edge 52 of base plate 14 to more positively maintain the desired alignment between frame 12 and ram 44 by preventing shifting of frame 12 during performance of a fragility test. Press 42 may also include means for measuring and indicating the amount of force applied to food bar specimen 22.

To conduct a food bar fragility test, arm 32 is pivoted upward to allow food bar specimen 22 to be positioned on rods 18 and 20. End wall 24 of food bar 22 is abutted against the inner surface 26 of sidewall 16 of frame 12. After so positioned, arm 32 is pivoted downward by means of hinge 40 until flange end 36 contacts top surface 58 of food bar 22. Flange end 36 contacts food bar 22 in a manner which bisects the length of food bar 22, as well as bisecting the distance between support rods 18, 20. Flange end 36 preferably contacts food bar 22 along its entire width. Ram 44 is then advanced axially downward to contact arm 32 and a measured force is applied to flange 34 in a downward direction to determine whether the food bar specimen is capable of withstanding such force without fracturing. Preferably, frame 12 is positioned on table 46 so that ram 44 is aligned to contact arm 32 at a predetermined location along arm 32, such as for example, adjacent the outer edge 60 of arm 32 with the edge 62 of ram 44 spaced ⅛ inch from outer edge 60 of arm 32. This allows standardization of the amount of force applied to food bar specimen 22 relative the amount of force supplied by ram 44, and hence provides consistent fragility test results.

In another aspect of the invention, fragility test apparatus 10 is used to classify the fragility strength of a series of food bar specimens. In this aspect of the invention the amount of force applied provided by press 42 is increased until fracture of the food bar specimen occurs. After the fracture, the amount of force require to fracture food bar test specimen 22 is noted. In order to classify relative fragility among a variety of food bars, a series of specimen bars is prepared. For example, the food bars of the series can all have granola as its principle ingredient and each bar may vary as to its other ingredients and inclusions. In some instances, the preparation and cooking conditions may also be varied. The composition of each bar and any other variables are noted. Also recorded is the weight of each composition as well as the overall weight of the bar. Each bar is formed of the same shape and dimensions. A benchmark is selected for the amount of force a food bar specimen must be able to withstand to be classified as non-fragile. For example, those food bar specimens capable of withstanding a force of 3 pounds without fracturing may be classified as non-fragile, while those failing to withstand such a force would be classified as fragile.

By testing a variety of food bar test specimens, data can be developed which allows prediction of the fragility within a certain kind of food bar, for example granola food bars, and how the fragility within that kind is affected as other ingredients and inclusions are varied. The fragility of one kind of food bar can also be compared to another kind of food bar, i.e. oatmeal to peanut butter bars. By classification of numerous food bar specimens as fragile or non-fragile, a data base is generated to aid and enhance the development of new food bar recipes and formulations that will exhibit desired structural strength requirements.

In another aspect of the invention food bar fragility tester 10 is used for quality control functions in a commercial food bar manufacturing facility. For example, food bars may be selected from a food bar production line prior to packaging and positioned on food bar testing apparatus 10 to conduct a test for the purpose of determining if that sample is capable of withstanding a certain level of force applied to food bar 22. In order to meet acceptable structural expectations for a food bar, it has been determined that it is desirable that a commercially sold food bar be capable of withstanding a benchmark force in the range of about 2.5 to about 4 pounds in fragility testing by the present invention as described above. For more a definitive quality control, food bar 22 preferably is capable of withstanding a benchmark force of 3 pounds or greater. Thus, food bar tester 10 can be utilized to monitor a production line for manufacturing food bars by providing quality control of the fragility characteristics of the food bars. If through quality control testing, it is determine that an undue percentage of food bars fail to withstand the required benchmark force, a quality control issue for the production line is indicated, and appropriate action may be taken.

Food fragility tester 10 may also be modified to provide portability by being adaptable to be capable of operating without the use of press 42. Portability allows testing to be conducted at locations remote from press 42. This may be accomplished by transporting frame 12 and attached force applying member 30, as shown in FIG. 3, directly to a production line of a manufacturing plant, for example. A free weight (not shown) of known value, matching that of the selected benchmark between fragility and non-fragility, for example, 3 pounds can be placed directly on top of arm 32 adjacent flange 34 to conduct a fragility test. If the food bar fractures under the weight applied, the food bar would be classified as fragile. If it does not fracture, it would be classified as non-fragile. To standardize the amount of force applied to food bar 22 by flange end 36, the free weight should always be positioned at the same location along the top surface 66 of arm 32, such as if the edge of the free weight is aligned flush with outer edge 60 of flange 34. Preferably, the free weight may be positioned along arm 32 so that, based on the center of gravity of the free weight, the force that the free weight creates at flange end 36 when contacting food bar 22, closely approximates that amount of indicted force when applied by ram 44. In other words, a free weight of 3 lbs is positioned along arm 32 so that it simulates and approximates a 3 lb force applied by ram 44 of press 42 at a location along arm 32 that is normally used as the standard location when applying force by means of ram 44. Thus, any tests conducted in a portable application of fragility tester 10 with a certain weight will indicate results consistent to those attainable with tests conducted with press 42 using that same amount weight of force.

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

Modifications may be made to the embodiments described above without departing from the broad inventive concepts thereof. Accordingly, the present invention is not limited to the particular embodiments nor to the theoretical description disclosed, but is intended to cover all modifications that are within the spirit and scope of the invention as defined in the appended claims.

What is claimed is:

1. A food bar fragility test apparatus for testing the fragility characteristics of a food bar specimen having a generally rectangle shape with a top, a bottom, a first end, a second end and a first and a second side, each of said sides a having a first length, said test apparatus comprising:
a frame, said frame including a base and a sidewall extending generally perpendicularly from said base,
a support structure for positioning and supporting a food bar test specimen, said support structure including a first support rod and a second support rod, said support and positioning structure also including said sidewall of said frame, said first support rod and said second support rod positioned on said base parallel to each other and parallel to said sidewall of said frame, said first support rod spaced from said sidewall a first distance, said second support rod positioned a second distance from said sidewall of said frame, said support structure for positioning and supporting said food bar specimen also including a surface of said frame sidewall for engaging said first end of said sidewall for restraining axial movement in one direction of said food bar specimen,
a force transmitting member and a hinge for pivotally attaching said force transmitting member to said sidewall of said frame, said force transmitting member including an arm and a force applying surface connected to said arm, said force applying surface for contacting said specimen to apply a force to said specimen, said arm pivotable to a specimen loading position to allow positioning of said specimen in relationship with said support structure, and pivotable to a specimen engagement position wherein said force applying surface engages said specimen, said arm having a second length sufficient to space said force transmitting surface from said sidewall of said frame to cause said force applying surface to contact said specimen along a line which bisects said first length of said specimen when said specimen is positioned on said support rods with said first end of said specimen abutting against said sidewall of said frame and said arm is pivoted to said specimen engagement position,
a force generator for generating a measurable and reproducible amount of force applied to said arm so that said force is transmitted by said force applying surface to said food bar specimen to determine whether said specimen can withstand said force or whether said force fractures said specimen.

2. The food bar fragility test apparatus of claim 1 wherein said first distance is approximately equal said second distance, and said first distance is at least one eight of said first length of said food bar and no more than about one fifth of said first length of said food bar specimen.

3. The food bar fragility test apparatus of claim 2 wherein said first distance is approximately equal to 0.5 inch.

4. The food bar fragility test apparatus of claim 2 wherein said food bar test apparatus is for testing food bar specimens having said first length that is between about 3 to about 3.5 inches.

5. The food bar fragility test apparatus of claim 2 wherein said amount of force applied by said testing apparatus is about 2.5 to about 4 pounds.

6. The food bar fragility test apparatus of claim 2 wherein said force generator includes a reciprocating ram, said ram movable between a first position spaced away from said arm to allow said arm to pivot to said specimen loading position, and said ram axially movable to a second position contacting said arm to apply said force when said arm is in the force applying position.

7. The food bar fragility test apparatus of claim 1 wherein said force generator is a weight placed on said arm.

8. The food bar fragility test apparatus of claim 6 wherein said support and positioning frame is aligned with said ram and said force transmitting member includes a flange depending from said arm, said flange having an end, said end of said flange providing said force applying surface, said ram in alignment with said flange when said arm is pivoted to said specimen engagement position so that said ram contacts said arm adjacent to said flange when applying said force to said specimen.

9. The food bar fragility test apparatus of claim 5 where in said weight is a free weight, and said force transmitting member includes a flange depending from said arm, said flange having an end, said end of said flange providing said force applying surface, said weight position on said arm adjacent said flange when said arm is pivoted to said specimen engagement position.

10. The food bar fragility test apparatus of claim 8 wherein said apparatus includes a table having a surface, and said frame being supported on said table surface, at least one stop projecting from said table surface, said stop cooperating with said frame to align said frame with said ram and to prevent shifting of said frame when conducting a fragility test.

11. A method of classifying a food bar composition's relative fragility,
forming a group of food bar specimens, said specimens each having a generally bar like shape and having a first side and a second side, a first end and a second end, a top surface and a bottom surface so that the dimensions of each specimen are approximately the same,
individually testing a plurality of said specimens by the following steps,
placing said a specimen on a support and positioning structure having at least a first surface, a second surface, and a third surface, said first structure surface for supporting said specimen at its bottom surface along a first line parallel to said first end of said specimen, said first line spaced a first distance from said first end of said specimen, and said second structure surface supporting said specimen along a second line at said bottom surface of said specimen, said second line parallel to said second end of said specimen and spaced a second distance from said second edge, said second distance being equal to said first distance, said bottom surface of said specimen being unsupported except along said first and second lines,
indexing the position of said specimen with in said support and positioning structure by positioning said first end of said specimen against said third structure surface by abutting said first end of said specimen against said third structure surface, said third surface of said structure being parallel to said first and second structuring surface,
restraining said first edge of said specimen at said third structure surface from axial movement in one direction,
applying a measured force to said top surface of said specimen along a third line parallel to said first and second lines, said third line bisecting said first and second lines,
setting a minimum standard benchmark of acceptable fragility for said food bar specimens based upon a food bar specimen being able to withstand an amount of said applied force equal to said benchmark or greater,
classifying a food bar specimen composition as non-fragile if said food bar specimen does not fracture when at least said benchmark amount of force is applied to said food bar specimen, and
classifying said food bar composition as fragile if said food bar specimen fractures when less than said benchmark force is applied to food bar specimen.

12. The method of claim 11 further characterized by, said food bar specimens being formed of varying compositions, said force is applied until said food bar is fractured, measuring the force at which said fracture occurs, developing a data base of the fragility of said food bars of varying formulations, and utilizing said data base in selection of formulations for manufacturing food bars.

13. The method of claim 12 wherein said benchmark of force is between about 2.5 to about 4 pounds.

14. The method of claim 13 wherein said benchmark force is about 3 pounds.

15. The method of claim 14 wherein said specimen has a length between about 3 inches to about 3.5 inches.

16. The method of claim 15 wherein said specimen has a width of between about 1 inch and about 1.5 inches, a thickness of about 0.375 inch to about 0.5 inch.

17. The method of claim 11 and wherein said force is a applied by an arm having a flange connected thereto, said flange providing a force applying surface for applying said force to said top surface of said specimen, and said force is generated by a free weight placed on said top surface of said arm adjacent said flange.

18. The method of claim 11 and wherein said force is a applied by an arm having a flange connected thereto, said flange providing a force applying surface for applying said force to said top surface of said specimen, and said force is generated by a free weight placed on said top surface of said arm adjacent said flange. 19. The method of claim 11 wherein said specimens are obtained from a food bar production line and said test is a quality control test, said specimen passing said test and classified as non-fragile if said specimen does not fracture when at least said benchmark force is applied, and said specimen being classified as fragile if said specimen fractures when less than said benchmark force is applied.
